(19) United States
(12) Patent Application Publication
(10) Pub. No.: US 2014/0284920 A1
(43) Pub. Date: Sep. 25, 2014

(54) FISH-MOUTH PIPE FITTNG AND METHOD OF ASSEMBLING PIPES AT VARIOUS ANGLES

(71) Applicant: CREATIVE FITTINGS & MORE , LLC, ROCKPORT, IN (US)

(72) Inventors: DANIEL R. TODD, ROCKPORT, IN (US); DENNIS R. TODD, RICHLAND, IN (US); EVAN M. YOUNG, ROCKPORT, IN (US)

(73) Assignee: CREATIVE FITTINGS & MORE , LLC, ROCKPORT, IN (US)

(21) Appl. No.: 13/849,610

(22) Filed: Mar. 25, 2013

(51) Int. Cl. F16L 21/00

(52) U.S. Cl. CPC F16L 21/007
USPC 285/184

(57) ABSTRACT

A method and apparatus for joining a first length of pipe to a second length of pipe at an arbitrary angle is provided. The apparatus includes a fitting having a substantially circular opening at a first end thereof for receiving an end of a first length of pipe, and a fish-mouth shaped opening at a second end thereof for receiving an end of a second length of pipe. One or more wedges are provided for insertion into a gap between the fitting and the second length of pipe. The one or more wedges may be inserted at either an elongated end or a straight end of the fish-mouth shaped opening, or both. Adhesive, such as PVC cement may be used to bond the various fittings, wedges and length of pipe together to form a sealed joint.

### FIELD OF THE INVENTION

The present invention relates generally to pipe fittings, and methods of assembling pipe fittings, and in particular to a pipe fitting and method for assembling pipes at various angles.

### BACKGROUND OF THE INVENTION

A variety of fittings and connectors have previously been developed for joining fluid-conveying pipes and other components. Common connectors include couplings, crosses, elbows, tees, unions and wyes. These connectors are used to join two lengths of pipe, such as PVC pipe for carrying fluids. Elbows are used to account for direction changes in the pipe string. Common elbow fittings are at fixed angles and include 90 degree elbows, 45 degree elbows, and 22½ degree elbows.

Flexible couplings, such as those manufactured by Fernco, also exist in the marketplace. While flexible, these couplings are limited in their range of motion to approximately 5 degrees and cost significantly more than standard PVC pipe. Further, these couplings require pipe clamps to be placed at each end of the fitting to secure the coupling to the pipe, and are made of rubber.

Swivel or ball fittings, such as are disclosed in U.S. Pat. No. 2,286,565, have also been used to allow for connecting pipes that are not aligned at angles which are common to elbow fittings as discussed above. However, these types of fittings have multiple additional parts and components, such as o-rings, compression fittings and the like, that can create additional opportunities for leakage.

### SUMMARY OF THE INVENTION

The present invention overcomes these limitations by providing a variable fitting that has no gaskets, swivels, or moving parts that could leak. The device and method of the present invention are intended to replace existing pipe fittings that only provide for a fixed angle or are made of flexible materials that are inferior due to the lack of rigidity and increased risk of failure or blockage.

Use of the present invention allows for joining of two pipes together at arbitrary angles. It also replaces the need to stock several fixed angle pipe fittings, such as 45 degree and 22½ degree fittings.

According to one aspect of the present invention, there is provided an apparatus for joining a first length of pipe to a second length of pipe at an arbitrary angle. The apparatus includes a fitting having a substantially circular opening at a first end thereof for receiving an end of said first length of pipe, and a fish-mouth shaped opening at a second end thereof for receiving an end of said second length of pipe. One or more wedges are provided for insertion into a gap between the fitting and the second length of pipe. The one or more wedges may be inserted at either an elongated end or a straight end of the fish-mouth shaped opening.

Yet another aspect of the invention includes a first wedge for insertion into a gap between the fitting and the second length of pipe at an elongated end of the fish-mouth shaped opening, and a second wedge for insertion into a gap between the fitting and the second length of pipe at a straight end of the fish-mouth shaped opening. The first wedge includes an upper surface joined to an inner surface at a first edge, a lower surface joined to said upper surface at a second edge, and a third edge joining the lower surface to the inner surface and forming a bottom point of the wedge. The shape and profile of the lower surface corresponds generally to the shape of the elongated side of the fish-mouth opening. The second wedge includes an upper surface joined to an inner surface at a first edge, an outer surface joined to the upper surface at a second edge, and a third edge joining the outer surface to the inner surface and forming a bottom point of the wedge. The shape and profile of the outer surface corresponds generally to the shape of the straight side of the fish-mouth opening.

According to another aspect of the invention, adhesive may be interposed between the various components of the apparatus for bonding the components together. In addition, a plurality of first wedges of varying dimension and a plurality of second wedges of varying dimensions may also be utilized.

Another aspect of the present invention is a method for joining a first length of pipe to a second length of pipe at an arbitrary angle. Adhesive is applied to one or more of an outer surface of an end of the second length pipe and an inner surface of a fish-mouth opening in a fitting. The end of the second length of pipe is then inserted into the fish-mouth opening at a predetermined angle. The length of pipe may then be rotated relative to the fitting. Next, adhesive is applied to one or more wedges. Finally, said one or more wedges are driven into a gap between the outer surface of the second length of pipe and the inner surface of the fish-mouth opening.

Another aspect of the method includes applying adhesive to a lower surface and an inner surface of a first wedge; driving said first wedge into a gap between the outer surface of the second length of pipe and the inner surface of the fish-mouth opening at an elongated end of the opening; applying adhesive to an outer surface and an inner surface of a second wedge; and driving said second wedge into a gap between the outer surface of the second length of pipe and the inner surface of the fish-mouth opening at a straight end of the opening.

A further aspect of the method includes the steps of applying primer to the various components to be bonded. Specifically primer may be applied to one end of the outer surface of the second pipe and the inner surface of the fish-mouth opening prior to the step of applying adhesive to one or more of an outer surface of an end of the second length pipe and an inner surface of a fish-mouth opening. In addition, primer may also be applied to said one or more wedges prior to the step of applying adhesive to said one or more wedges.

These and other objects, features and advantages of the present invention will become apparent with reference to the text and the drawings of this application.

### BRIEF DESCRIPTION OF THE DRAWINGS

FIG. 1 is a top perspective view of a fish mouth pipe fitting according to a presently preferred embodiment of the invention.

FIG. 2 a top perspective view of a pair of wedges for use in connection with the fish mouth pipe fitting shown in FIG. 1, according to a presently preferred embodiment of the invention.

FIG. 3 is a top perspective view of the fish mouth pipe fitting shown in FIG. 1 with a second pipe fitted in the opening thereof.

FIG. 4A is a side sectional view of the fish mouth pipe fitting with a second pipe fitted in the opening thereof as shown in FIG. 3.

FIG. 4B is a side sectional view of the fish mouth pipe fitting with a second pipe fitted in the opening thereof as shown in FIG. 4A with the angle of the second pipe to the fish mouth pipe fitting slightly altered.

FIG. 4C is a side sectional view of the fish mouth pipe fitting with a second pipe fitted in the opening thereof as shown in FIG. 4B with the angle of the second pipe to the fish mouth pipe fitting slightly altered.

FIG. 4D is a side sectional view of the fish mouth pipe fitting with a second pipe fitted in the opening thereof as shown in FIG. 4C with the angle of the second pipe to the fish mouth pipe fitting slightly altered.

FIG. 4E is a side sectional view of the fish mouth pipe fitting with a second pipe fitted in the opening thereof as shown in FIG. 4D with the angle of the second pipe to the fish mouth pipe fitting slightly altered to a substantially straight position.

FIG. 5A is a side sectional view of the fish mouth pipe fitting with a second pipe fitted in the opening thereof as shown in FIG. 3, shown here with a wedge, according to one presently preferred embodiment as shown in FIG. 2 inserted on one side.

FIG. 5B is a side sectional view of the fish mouth pipe fitting with a second pipe fitted in the opening thereof as shown in FIG. 5A with the angle of the second pipe to the fish mouth pipe fitting slightly altered, and also shown here with wedges inserted on both sides.

FIG. 5C is a side sectional view of the fish mouth pipe fitting with a second pipe fitted in the opening thereof as shown in FIG. 5B with the angle of the second pipe to the fish mouth pipe fitting slightly altered, and also shown here with wedges inserted on both sides.

FIG. 5D is a side sectional view of the fish mouth pipe fitting with a second pipe fitted in the opening thereof as shown in FIG. 5C with the angle of the second pipe to the fish mouth pipe fitting slightly altered, and also shown here with wedges inserted on both sides.

FIG. 5E is a side sectional view of the fish mouth pipe fitting with a second pipe fitted in the opening thereof as shown in FIG. 5D with the angle of the second pipe to the fish mouth pipe fitting slightly altered to a substantially straight position, and also shown here with a wedges inserted on one side.

FIG. 6A is a side sectional view of the fish mouth pipe fitting with a second pipe fitted in the opening thereof as shown in FIG. 3, shown here with a wedge, according to an alternative preferred embodiment, shown inserted on one side.

FIG. 6B is a side sectional view of the fish mouth pipe fitting with a second pipe fitted in the opening thereof as shown in FIG. 6A with the angle of the second pipe to the fish mouth pipe fitting slightly altered, and also shown here with wedges inserted on both sides.

FIG. 6C is a side sectional view of the fish mouth pipe fitting with a second pipe fitted in the opening thereof as shown in FIG. 6B with the angle of the second pipe to the fish mouth pipe fitting slightly altered, and also shown here with wedges inserted on both sides.

FIG. 6D is a side sectional view of the fish mouth pipe fitting with a second pipe fitted in the opening thereof as shown in FIG. 6C with the angle of the second pipe to the fish mouth pipe fitting slightly altered, and also shown here with wedges inserted on both sides.

FIG. 6E is a side sectional view of the fish mouth pipe fitting with a second pipe fitted in the opening thereof as shown in FIG. 6D with the angle of the second pipe to the fish mouth pipe fitting slightly altered to a substantially straight position, and also shown here with a wedges inserted on one side.

### DETAILED DESCRIPTION OF PREFERRED EMBODIMENTS

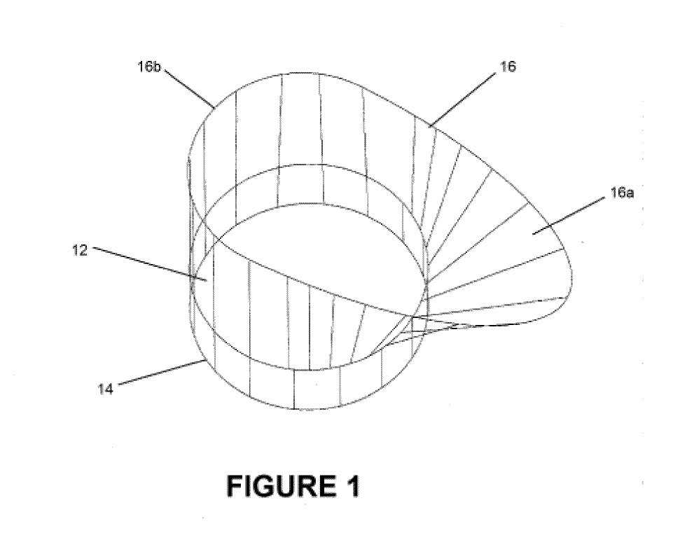

As shown in FIG. 1, the present invention is an innovative pipe connector 10 having a fitting 12 which has a substantially circular opening 14 at a first end thereof, and a fish-mouth shaped opening 16 and a second end thereof. The circular opening 14 at the first end is configured to receive an end of a pipe (not shown) therein. The size of the circular opening 14 corresponds to the exterior diameter of the pipe to be received therein such that a tight, friction fit is created. For example, standard PVC and CPVC pipe, schedule 40 and schedule 80, used in plumbing applications have nominal diameters of ½″, ¾″, 1″, 1¼″, 1½″, 2″, 2½″, 3″, 4″, 5″, 6″, 8″, 10″, 12″, 14″ and 16″. The circular opening 14 may preferably be sized to accommodate one of these pipe sizes. Alternatively, the fish-mouth shaped opening 16 can be formed directly into the end of a length of pipe.

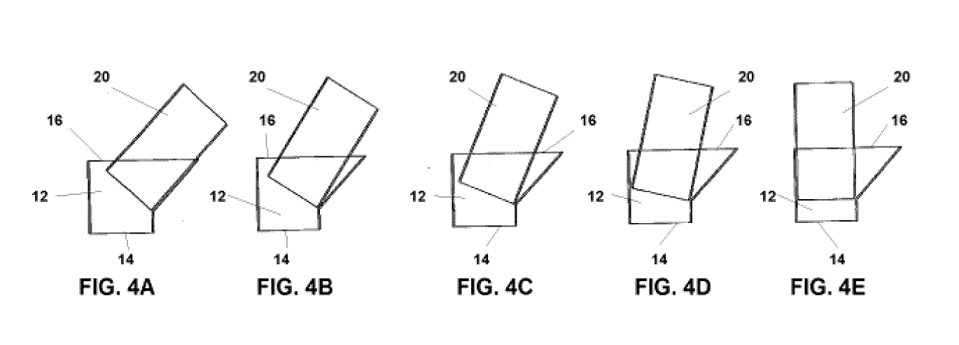

The fish-mouth opening 16 in the second end of the fitting 12 allows for a pipe 20 to be inserted into the opening 16 at a variety of angles, as best shown in FIGS. 4A-4E. According to the presently preferred embodiment of the invention, angles ranging from 42 degrees (FIG. 4A) to 0 degrees (FIG. 4E). The specific geometry of the fish-mouth opening 16 can be varied to accommodate a greater or lesser range of angles without departing from the spirit of the invention. An infinite number of angles between 0 degrees and 42 degrees, including the specific angles shown in FIGS. 4B-4D, can be achieved.

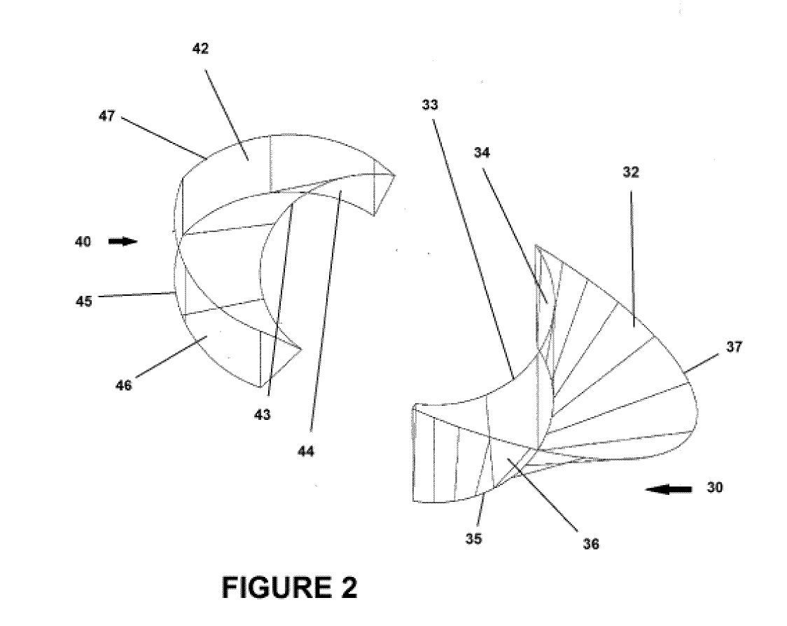

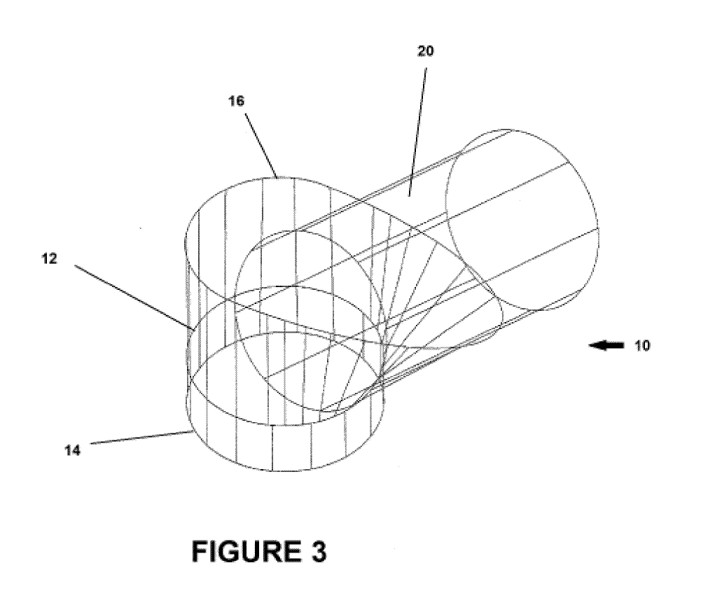

As shown in FIG. 2, a pair of wedges 30, 40 may be provided to provide additional stability to the connection once the pipe 20 has been set in the fish-mouth opening 16 at the desired angle. According to the embodiment shown in FIG. 2, the first wedge 30 is configured to be inserted into the elongated side 16a the fish-mouth opening 16. Similarly, the second wedge 40 is configured to be inserted into the straight side 16b of the fish-mouth opening 16.

The first wedge 30 has an upper surface 32 joined to an inner surface 34 at edge 33. The upper surface 32 is joined to a lower surface 36 at edge 37. Finally, the lower surface 36 and inner surface 34 come together at edge 35 to form the bottom point of the wedge. The shape and profile of the lower surface 36 corresponds generally to the shape of the elongated side 16a of the fish-mouth opening 16. When inserted into the opening, the inner surface 34 of the wedge 30 comes into contact with the outer surface of the pipe 20.

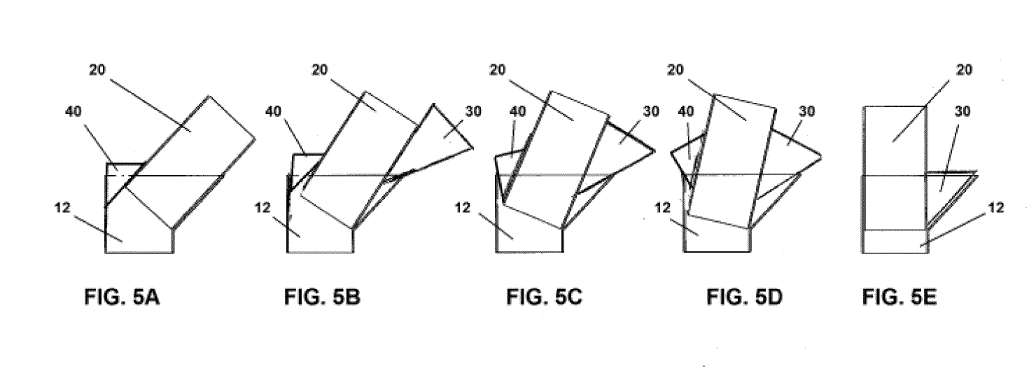

According to the preferred embodiment shown in FIG. 2, the angle of the lower surface 34 is such that, when the fitting is configured at an angle of 0 degrees (FIG. 5E), the entire lower surface 34 is substantially in contact with the surface of the fitting 12 at the elongated side 16a of the fish-mouth opening 16, and the entire inner surface 34 is substantially in contact with the outer surface of pipe 20. When using this particular configuration, however, as shown in FIGS. 5B-5D, contact with the elongated side 16a of the fish-mouth opening 16 and/or contact with the outer surface of the pipe 20 diminishes as the angle increases.

The second wedge 40 has an upper surface 42 joined to an inner surface 44 at edge 43. The upper surface 42 is joined to an outer surface 46 at edge 47. Finally, the outer surface 46 and inner surface 44 come together at edge 45 to form the bottom point of the wedge. The shape and profile of the outer surface 46 corresponds generally to the shape of the straight side 16b of the fish-mouth opening 16. When inserted into the opening, the inner surface 44 of the wedge 40 comes into contact with the outer surface of the pipe 20.

According to the preferred embodiment shown in FIG. 2, the angle of the outer surface 44 is such that, when the fitting is configured at an angle of 42 degrees (FIG. 5A), the entire outer surface 44 is substantially in contact with the surface of the fitting 12 at the straight side 16b of the fish-mouth opening 16, and the entire inner surface 44 is substantially in contact with the outer surface of pipe 20. When using this particular configuration, however, as shown in FIGS. 5B-5D, contact with the straight side 16b of the fish-mouth opening 16 and/or contact with the outer surface of the pipe 20 diminishes as the angle decreases.

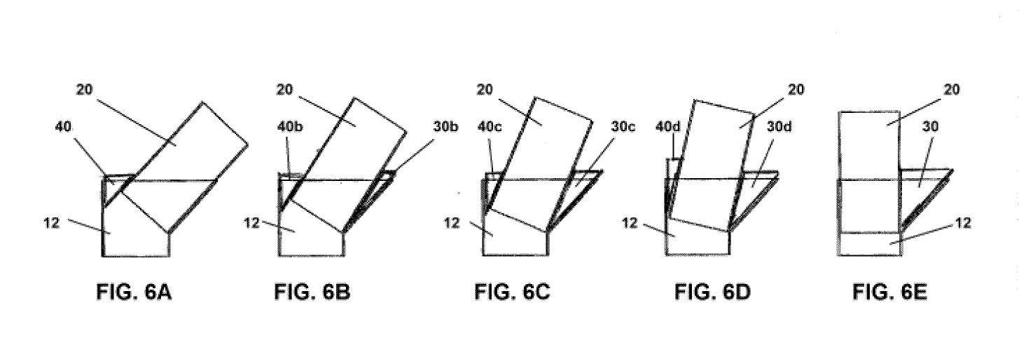

According to an alternative embodiment, as shown in FIGS. 6A-6E, first and second wedges of varying dimensions can be employed to improve surface contact at angles nearer the mid-point. Specifically, the dimensions of the first wedge 30 can be varied by reducing the distance between inner edge 33 and outer edge 37 to achieve first wedges 30b, 30c, 30d of different dimensions. Similarly, the dimensions of the second wedge 40 can be varied by reducing the distance between inner edge 43 and outer edge 47 to achieve second wedges 40b, 40c, 40d of different dimensions.

The fitting is assembled by first priming one end of the outer surface of the pipe 20 and the inner surface of the fish-mouth opening 16. Glue or PVC cement is then applied to the outer surface of the end of the pipe 20 and/or the inner surface of the fish-mouth opening 16. The end of the pipe 20 is then inserted into the fish-mouth opening 16 at the desired angle and given a quarter turn. Once the glue/cement is dry, primer is applied to both the first wedge 30 and second wedge 40. Glue or PVC cement is then applied to the inner surface 34 and lower surface 36 of the first wedge 30 and the first wedge 30 is driven into place on the elongated side 16a of the fish-mouth opening 16. Glue or PVC cement is then applied to the inner surface 44 and outer surface 46 of the second wedge 40, and the second wedge 40 is driven into place on the straight side 16b of the fish-mouth opening 16. Once the glue is dried, the fitting is ready for use.

The pipe connector 10 including fitting 12, pipe 20, first wedge 30 and second wedge 40 are preferably formed of a plastic material such as PVC or CPVC. Other plastics, such as ABS, SDR 21, SDR 26, as well as others that may now, or in the future be used in plumbing applications, may also be used. Other rigid or semi-rigid materials other than plastics, such as metals or composite materials, are also contemplated.

The foregoing is provided for purposes of illustrating, explaining, and describing embodiments of the present invention. The specific components and order of the steps listed above, while preferred is not necessarily required. Further modifications and adaptation to these embodiments will be apparent to those skilled in the art and may be made without departing from the scope or spirit of the invention.

1. An apparatus for joining a first length of pipe to a second length of pipe at an arbitrary angle comprising:
a fitting having a substantially circular opening at a first end thereof for receiving an end of said first length of pipe, and a fish-mouth shaped opening at a second end thereof for receiving an end of said second length of pipe; and
one or more wedges for insertion into a gap between the fitting and the second length of pipe.

2. The apparatus of claim 1, wherein said one or more wedges comprises a wedge for insertion into a gap between the fitting and the second length of pipe at an elongated end of the fish-mouth shaped opening.

3. The apparatus of claim 1, wherein said one or more wedges comprises a wedge for insertion into a gap between the fitting and the second length of pipe at a straight end of the fish-mouth shaped opening.

4. The apparatus of claim 1, wherein said one or more wedges comprises:
a first wedge for insertion into a gap between the fitting and the second length of pipe at an elongated end of the fish-mouth shaped opening; and
a second wedge for insertion into a gap between the fitting and the second length of pipe at a straight end of the fish-mouth shaped opening.

5. The apparatus of claim 4, wherein the first wedge comprises:
an upper surface joined to an inner surface at a first edge;
a lower surface joined to said upper surface at a second edge; and
a third edge joining the lower surface to the inner surface and forming a bottom point of the wedge.

6. The apparatus of claim 5, wherein the shape and profile of the lower surface corresponds generally to the shape of the elongated side of the fish-mouth opening.

7. The apparatus of claim 4, wherein the second wedge comprises:
an upper surface joined to an inner surface at a first edge;
an outer surface joined to the upper surface at a second edge; and
a third edge joining the outer surface to the inner surface and forming a bottom point of the wedge.

8. The apparatus of claim 7, wherein the shape and profile of the outer surface corresponds generally to the shape of the straight side of the fish-mouth opening.

9. The apparatus of claim 1 further comprising adhesive interposed between the various components of the apparatus for bonding said components together.

10. The apparatus of claim 4, further comprising a plurality of first wedges of varying dimension and a plurality of second wedges of varying dimensions.

11. A method for joining a first length of pipe to a second length of pipe at an arbitrary angle comprising the steps of:
applying adhesive to one or more of an outer surface of an end of the second length pipe and an inner surface of a fish-mouth opening in a fitting;
inserting the end of the second length of pipe into the fish-mouth opening at a predetermined angle;
rotating the length of pipe relative to the fitting;
applying adhesive to one or more wedges; and
driving said one or more wedges into a gap between the outer surface of the second length of pipe and the inner surface of the fish-mouth opening.

12. The method of claim 11, wherein the steps of applying adhesive and driving wedges further comprises the steps of:
applying adhesive to a lower surface and an inner surface of a first wedge;
driving said first wedge into a gap between the outer surface of the second length of pipe and the inner surface of the fish-mouth opening at an elongated end of the opening;
applying adhesive to an outer surface and an inner surface of a second wedge; and
driving said second wedge into a gap between the outer surface of the second length of pipe and the inner surface of the fish-mouth opening at a straight end of the opening.

13. The method of claim 11, further comprising the step of applying primer to one end of the outer surface of the second pipe and the inner surface of the fish-mouth opening prior to the step of applying adhesive to one or more of an outer surface of an end of the second length pipe and an inner surface of a fish-mouth opening.

14. The method of claim 13, further comprising the step of applying primer to said one or more wedges prior to the step of applying adhesive to said one or more wedges.
